(19) United States
(12) Patent Application Publication
(10) Pub. No.: US 2012/0306941 A1
(43) Pub. Date: Dec. 6, 2012

(54) Method and Device for Controlling Signal-Processing of the Backlight Module of the Display Device

(75) Inventor: Chen-Hsin Chang, Taipei City (TW)

(73) Assignee: COMPAL ELECTRONICS, INC., Taipei City (TW)

(21) Appl. No.: 13/483,279

(22) Filed: May 30, 2012

Related U.S. Application Data
(60) Provisional application No. 61/492,356, filed on Jun. 1, 2011.

(51) Int. Cl. G09G 5/10

(52) U.S. Cl. 345/690

(57) ABSTRACT

A power-saving technology of a display device is provided, in which a device and a method are proposed to control the signal processing of the backlight module such that it is synchronized with the backlight and a frame output signal. The device comprises a signal generation module for generating a vertical synchronization (VSYNC) signal having a first and a second state in each time period and a first pulse width modulation (PWM) signal and a modulation control module for receiving the VSYNC and the first PWM signals. The modulation control module transmits the first PWM signal to the backlight module when the VSYNC signal is in the first state such that the backlight module operates accordingly. The modulation control module transmits a second PWM signal to the backlight module when the VSYNC signal is in the second state such that the backlight module turns off.

### RELATED APPLICATIONS

The application claims priority to Provisional Application Ser. No. 61/492,356 filed on Jun. 01, 2011, which is herein incorporated by reference.

### BACKGROUND

1. Technical Field

The present disclosure relates to a power-saving technology of the display device. More particularly, the present disclosure relates to a method and a device for controlling a signal processing of a backlight module of a display device to synchronize the backlight and the frame output signal to save power of the display device.

2. Description of Related Art

The importance of the display technology grows with the development of diverse kinds of electronic devices. In common display device such as TFT (thin film transistor) LCD (liquid crystal display) device, backlight module becomes a critical part of a LCD device. As LCDs do not produce light themselves (unlike for example Cathode ray tube (CRT) displays), they need illumination (ambient light or a special light source) to produce a visible image. The backlight module illuminates a LCD from the side or back of the display panel. Eyes of the user can perceive the light from the backlight modules that penetrates through elements such as a polarizing plate, a glass substrate, a liquid crystal layer and color filters.

The backlight module consumes lots of power. Many new technologies are proposed to minimize the power consumption of the backlight module. However, it is a great challenge to design a backlight module consumes lower power without affecting the perception of the user.

Accordingly, what is needed is a method and a device for controlling a signal processing of a backlight module of a display device to save power of the display device without affecting the perception of the user.

### SUMMARY

An aspect of the present disclosure is to provide a device for controlling a signal processing of a backlight module of a display device to synchronize the backlight and the frame output signal to save power of the display device. The device comprises a signal generation module and a modulation control module.

The signal generation module generates a vertical synchronization (VSYNC) signal and a first pulse width modulation (PWM) signal, wherein the VSYNC signal has a first and a second state in each time period. The modulation control module receives the VSYNC signal and the first PWM signal. When the received VSYNC signal is in the first state, the modulation control module transmits the first PWM signal to the backlight module such that the backlight module operates accordingly. When the VSYNC signal is in the second state, the modulation control module transmits a second PWM signal to the backlight module such that the backlight module turns off.

Another aspect of the present disclosure is to provide a method for controlling a signal processing of a backlight module of a display device to synchronize the backlight and the frame output signal to save power of the display device. The method comprises the steps outlined below. A VSYNC signal and a first PWM signal are generated, wherein the VSYNC signal has a first and a second state in each time period. The VSYNC signal and the first PWM signal are received by a modulation control module. The backlight module is controlled by the modulation control module in response to the state of the VSYNC signal. Then the received VSYNC signal is in the first state, the modulation control module transmits the first PWM signal to the backlight module such that the backlight module operates accordingly. When the VSYNC signal is in the second state, the modulation control module transmits a second PWM signal to the backlight module such that the backlight module turns off.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of a display device in an embodiment of the present disclosure;

FIG. 2 is a block diagram of a device in an embodiment of the present disclosure for controlling a signal processing of the backlight module of the display device in FIG. 1 to synchronize the backlight and the frame output signal to save power of the display device;

FIG. 3 is a diagram of the waveforms of the VSYNC signal, the first PWM signal and the backlight control signal in an embodiment of the present disclosure;

FIG. 4 is a block diagram of the device in another embodiment of the present disclosure; and

FIG. 5 is a method for controlling a signal processing of a backlight module of a display device to save power of the display device.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

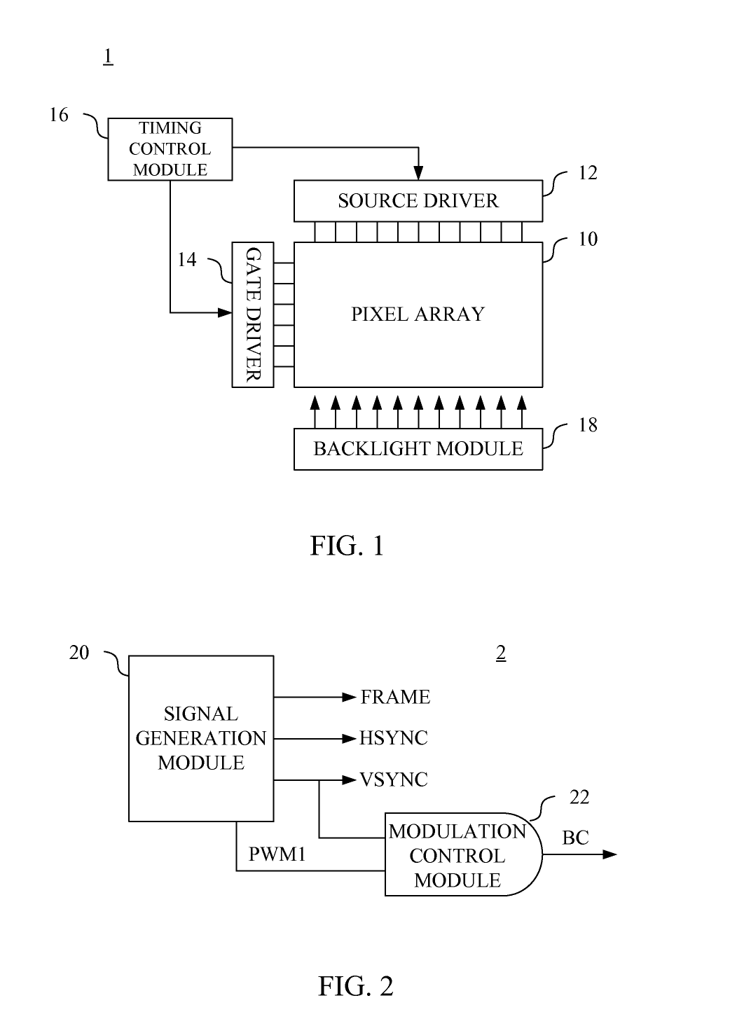

FIG. 1 is a block diagram of a display device 1 in an embodiment of the present disclosure. The display device 1 comprises a pixel array 10, a source driver 12, a gate driver 14, a timing control module 16 and a backlight module 18. The source driver 12 and the gate driver 14 are connected to the pixel units (not shown) of the pixel array 10. When the gate driver 14 turns on a row of the pixel units, the source driver 12 transmits display data to the pixel units such that the pixel units can display frames corresponding to the display data. The timing control module 16 controls the source driver 12 and the gate driver 14 to further control the time that the pixel units are turned on and the time the display data is transmitted. The backlight module 18 provides a light to the pixel array 10 such that the user can perceive the content displayed by the pixel array 10.

FIG. 2 is a block diagram of a device 2 in an embodiment of the present disclosure for controlling a signal processing of the backlight module 18 of the display device 1 in FIG. 1 to synchronize the backlight and the frame output signal to save power of the display device 1. The device 2 comprises a signal generation module 20 and a modulation control module 22.

The signal generation module 20 generates a vertical synchronization (VSYNC) signal, a horizontal synchronization (HSYNC) signal, a first pulse width modulation (PWM) signal and a plurality of frames. In an embodiment, the signal generation module 20 is a central processing unit disposed in a host (not shown) connected to the display device 1 in FIG. 1. The timing control module 16 determines when and how to transmit the display data having the plurality of frames to the pixel units of the pixel array 10 according to the VSYNC signal and the HSYNC signal. In an embodiment, the timing control module 16 transmits one of the frames in each of the time period in response to the VSYNC signal and transmits a row of the pixel data in one of the frames in each of the time period in response to the HSYNC signal.

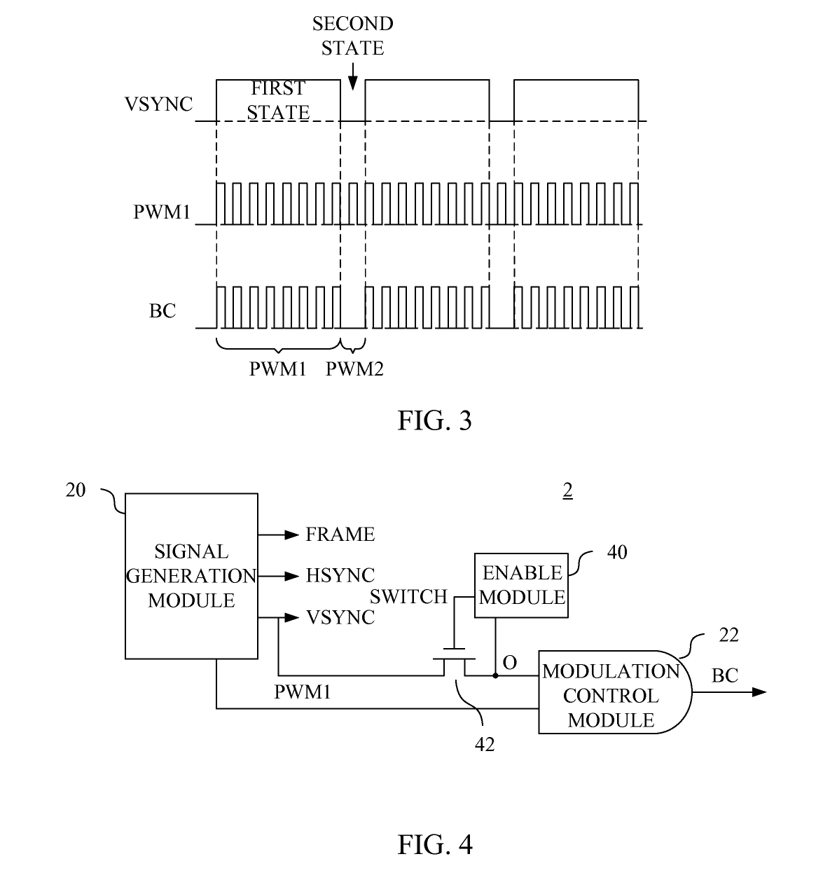

The modulation control module 22 receives the VSYNC signal and the first PWM signal and generates a backlight control (BC) signal accordingly to control the operation of the backlight module 18. FIG. 3 is a diagram of the waveforms of the VSYNC signal, the first PWM signal (depicted as PWM1) and the backlight control signal in an embodiment of the present disclosure.

The VSYNC signal has a first and a second state in each time period. In an embodiment, the first state of the VSYNC signal is a high state and the second state of the VSYNC signal is a low state. The timing control module 16 transmits one of the frames when the VSYNC signal is in the first state of each of the time period to the pixel array 10 and does not transmit any frame to the pixel array 10 when the VSYNC signal is in the second state of each of the time period.

The first PWM signal (PWM1) generated from the signal generation module 20 controls the operation of the backlight module 18, in which the pulse width of the first PWM signal (PWM1) controls the duration of the turn-on time and the turn-off time of the backlight module 18. In the present embodiment, the modulation control module 22 is a logic gate such as an AND gate. The backlight control signal generated is thus a logic operation result of the VSYNC signal and the first PWM signal (PWM1). As shown in FIG. 3, the modulation control module 22 transmits the first PWM signal (PWM1) to the backlight module 18 when the VSYNC signal is in the first state such that the backlight module 18 operates accordingly. On the other hand, the modulation control module transmits a second PWM signal (PWM2) to the backlight module 18 when the VSYNC signal is in the second state such that the backlight module 18 turns off. In the present embodiment, the second PWM signal (PWM2) is a horizontal low-level signal to turn off the backlight module 18.

In general, the frequency of the VSYNC signal is approximately 60 Hz such that the human eyes will not perceive any flicker. Hence, the human eyes will not notice the flicker when the backlight module 18 turns off during the second state of the VSYNC signal in each of the time period. Further, by using the control method described above, the power consumed by the backlight module 18 can be greatly reduced in comparison with the conventional backlight module. Accordingly, the device 2 for controlling the signal processing of the backlight module 18 of the display device 1 in the present disclosure can reduce the power consumption of the backlight module 18 without affecting the perception of the user. In an embodiment, the power consumption of the backlight module in the display device 1 depicted in FIG. 1 controlled by the device 2 can reduce 5% in comparison with the power consumption of the backlight module using the conventional PWM control mechanism. FIG. 4 is a block diagram of the device 2 in another embodiment of the present disclosure for controlling a signal processing of the backlight module 18 of the display device 1 in FIG. 1 to synchronize the backlight and the frame output signal to save power of the display device 1. The device 2 depicted in FIG. 4 further comprises an enable module 40 in comparison with the device 2 depicted in FIG. 2.

The enable module 40 generates an enable signal SWITCH to determine whether the control mechanism of the modulation control module 22 is activated. In the present embodiment, the enable signal SWITCH is used to control a switch 42 disposed on the path that the signal generation module 20 transmits the VSYNC signal to the modulation control module 22. The timing to activate the control mechanism of the modulation control module 22 can be determined accordingly. When the enable signal SWITCH is in an enable state, the modulation control module 22 starts to operate and when the enable signal SWITCH is in a disable state, the enable module 40 pulls the point O to a high state such that the modulation control module 22 bypasses the first PWM signal (PWM1) to the backlight module 18 such that the backlight module 18 operates accordingly. It is noticed that the implementation of the enable module 40 described above is only an example. In other embodiments, other architectures (e.g. a switch module) can be used to determine whether the control mechanism of the modulation control module 22 is activated.

In other embodiments, the signal generation module 20 can control the length of each of the time period, the length of the first state and the length of the second state by using software. The modulation control module 22 can thus control the backlight module 18 more elastically.

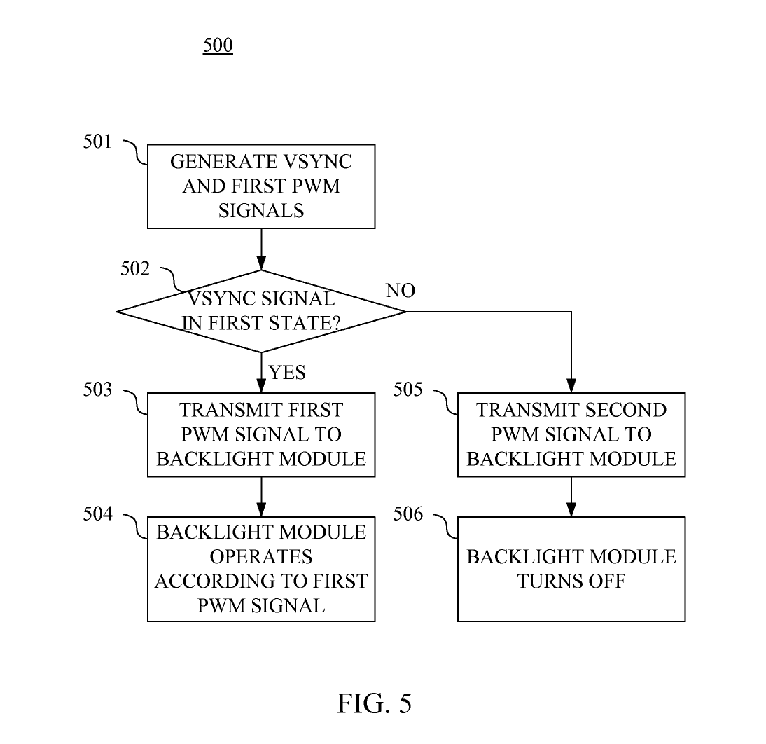

FIG. 5 is a method 500 for controlling a signal processing of a backlight module of a display device to save power of the display device. The method 500 can be used in the device 2 depicted in FIG. 2. The method 500 comprises the steps outlined below. It is noted that the steps are not recited in the sequence in which the steps must be performed. That is, unless the sequence of the steps is expressly indicated, the sequence of the steps is interchangeable, and all or part of the steps may be simultaneously, partially simultaneously, or sequentially performed.

In step 501, the VSYNC signal and the first PWM signal are generated, wherein the VSYNC signal has a first and a second state in each time period.

In step 502, whether the VSYNC signal is in the first state is determined. When the VSYNC signal is in the first state, the modulation control module 22 transmits the first PWM signal (PWM1) to the backlight module 18 in step 503 such that the backlight module 18 operates accordingly in step 504.

When the VSYNC signal is in the second state instead of the first state, the modulation control module 22 transmits the second PWM signal (PWM2) to the backlight module 18 in step 505 such that the backlight module 18 turns off in step 506.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A device for controlling a signal processing of a backlight module of a display device to save power of the display device, wherein the device comprises:
a signal generation module for generating a vertical synchronization (VSYNC) signal and a first pulse width modulation (PWM) signal, wherein the VSYNC signal has a first and a second state in each time period; and
a modulation control module for receiving the VSYNC signal and the first PWM signal;
wherein when the received VSYNC signal is in the first state, the modulation control module transmits the first PWM signal to the backlight module such that the backlight module operates accordingly;
when the VSYNC signal is in the second state, the modulation control module transmits a second PWM signal to the backlight module such that the backlight module turns off.

2. The device of claim 1, wherein the signal generation module further generates a plurality of frames and a horizontal synchronization (HSYNC) signal to a timing control module of the display device such that the timing control module transmits the frames to a pixel array of the display device in response to the VSYNC signal and the HSYNC signal to display the frames.

3. The device of claim 2, wherein the timing control module transmits one of the frames to the pixel array when the VSYNC signal is in the first state in each of the time period.

4. The device of claim 1, wherein the modulation control module is a logic gate.

5. The device of claim 1, further comprising an enable module for generating an enable signal to control the modulation control module, wherein when the enable signal is in an enable state, the modulation control module starts to operate and when the enable signal is in a disable state, the modulation control module bypasses the first PWM signal to the backlight module such that the backlight module operates accordingly.

6. The device of claim 1, wherein the signal generation module controls the length of each of the time period of the VSYNC signal and the length of the first state and the second stage in each of the time period of the VSYNC signal.

7. The device of claim 1, wherein the signal generation module is a host connected to the display device.

8. A method for controlling a signal processing of a backlight module of a display device to save power of the display device, wherein the method comprises:
generating a VSYNC signal and a first PWM signal, wherein the VSYNC signal has a first and a second state in each time period; and
receiving the VSYNC signal and the first PWM signal by a modulation control module;
controlling the backlight module in response to the state of the VSYNC signal by the modulation control module;
wherein when the received VSYNC signal is in the first state, the modulation control module transmits the first PWM signal to the backlight module such that the backlight module operates accordingly;
when the VSYNC signal is in the second state, the modulation control module transmits a second PWM signal to the backlight module such that the backlight module turns off.

9. The method of claim 8, further comprising generating a plurality of frames and a horizontal synchronization (HSYNC) signal to a timing control module of the display device such that the timing control module transmits the frames to a pixel array of the display device in response to the VSYNC signal and the HSYNC signal to display the frames.

10. The method of claim 9, wherein the timing control module transmits one of the frames to the pixel array when the VSYNC signal is in the first state in each of the time period.

11. The method of claim 8, further comprising determining the state of an enable signal to control the modulation control module, wherein when the enable signal is in an enable state, the modulation control module starts to operate and when the enable signal is in a disable state, the modulation control module bypasses the first PWM signal to the backlight module such that the backlight module operates accordingly.

12. The method of claim 8, wherein the step of generating the VSYNC signal further comprises controlling the length of each of the time period of the VSYNC signal and the length of the first state and the second stage in each of the time period of the VSYNC signal.
